(19) United States
(12) Patent Application Publication
(10) Pub. No.: US 2024/0309703 A1
(43) Pub. Date: Sep. 19, 2024

(54) SWIM LADDER FOR A DOCK

(71) Applicant: E-Z-DOCK, INC., Monett, MO (US)

(72) Inventors: Matthew Ricket, Charlotte, NC (US); Paul Recko, Denver, NC (US); Jeremy Williams, Monett, MO (US)

(21) Appl. No.: 18/591,764

(22) Filed: Feb. 29, 2024

Related U.S. Application Data
(60) Provisional application No. 63/490,122, filed on Mar. 14, 2023.

(51) Int. Cl. E06C 9/08

(52) U.S. Cl. CPC E06C 9/08

(57) ABSTRACT

A swim ladder assembly mountable to, for example, a dock, a raft, a float, or a boat, comprises a pair of side mount members and a swim ladder pivotally mounted between the side mount members. The swim ladder is designed to permit a swim ladder to rotationally pivot about a pivot axis and lock securely at specific orientations is disclosed herein. The pivot axis is positioned to be spaced above the dock surface and be spaced rearwardly from the edge of the dock to which the ladder is mounted so that a user does not have to reach out over the edge of the structure to rotate the ladder. A pin insert system to allow the swim ladder to be stowed in multiple different orientations without fear of free rotation. Arcuate handles at the top of the ladder provide structural support to the ladder as it transitions between orientations.

### CROSS-REFERENCE TO RELATED APPLICATIONS

This application claims priority to U.S. App. No. 63/490,122 entitled Swim Ladder for a Dock, which was filed on Mar. 14, 2023, the contents of which are incorporated herein by reference.

### STATEMENT REGARDING FEDERALLY SPONSORED RESEARCH OR DEVELOPMENT

Not Applicable.

### BACKGROUND

The subject matter described herein relates generally to a swim ladder, and in particular to a pivotal swim ladder for use with docks, rafts, boats, and the like.

The term ‘swim ladder’ refers to a well-known category of marine ladders, sometimes also called ‘dock ladders’ or ‘boat ladders,’ that are designed to aid a user in moving to and from docks, rafts, or boats and marine environments. Swim ladders are often deployed on boats, docks, or any structure that interfaces with a body of water amenable to swimmers. However, swim ladder designs vary, and not all designs can satisfy user needs of rapid adjustment, robust construction, and relative ease of deployment.

There are numerous commercially available swim ladders. However, they all have various drawbacks. For example, most commercially available pivotable swim ladders position their pivot point low and close to the edge of the dock (or other structure) to which they are mounted. This requires users to bend and reach out over the edge of the dock to pivot the ladder out of the water. This can be an uncomfortable and potentially unsafe angle to rotate the swim ladder, as the user could lose his/her balance. Positioning the pivot point for the ladder proximate the edge of the dock also makes the ladder more liable to move as swimmers use the ladder.

### SUMMARY

Thus, there is need for a swim ladder that features a sturdy, versatile construction, is pivotable, and features simple construction and ease of use. The swim ladder disclosed herein is easy to install on a variety of docks, rafts, or even boats. It features an elevated pivot point offset or spaced from the edge of the structure (such as a dock) to which the ladder is mounted so that a user does not have to reach out over the edge of the structure to rotate the ladder. Furthermore, the offset pivot point makes the ladder less likely to move when swimmers use the ladder. Positioning the pivot point at an elevated offset position further enables the placement of an uppermost ladder step that is much closer to the edge of the mounting structure, further improving ease of use.

Briefly, the swim ladder assembly comprises at least one side mount adapted to be mounted to a structure (such as for example, a dock section, a pier, a raft, or a boat) and a swim ladder rotatably mounted to the at least side mount. The structure comprises a top surface, a side or end surface, and an edge at a junction between the top and side or end surfaces. The side mount comprises a side mount pivot block positioned to be above the top surface of the structure and rearwardly of the edge when the side mount is mounted to the structure. The swim ladder is rotatable about a pivot axis between an in-use position in which the ladder extends into water and an out-of-use position in which the ladder does not extend into water.

The swim ladder comprises at least one side rail comprising an upper portion having upper edge defining an arc having a radius R, the radius R being approximately equal to distance between a bottom of the at least one side mount and the side mount pivot block and defining an angle of at least 90° and preferably less than 270°, preferably at least 100°, 110°, 120°, 130°, or 140°, and preferably less than 250°, 230°, or 200°, and more preferably no greater than 180°. A side rail pivot block is positioned in the upper portion to be at an approximate center of a circle defined by the arcuate upper edge. At least one leg rail extends from the swim ladder upper portion with at least one step fixed to the at least one leg rail. An axle extends through the side mount pivot block and the side rail pivot block to define the pivot axis about which the swim ladder is rotatable. The side rail upper portion is sized such that, as the swim ladder is pivoted between its in-use position and its out-of-use position, the arcuate edge of the upper portion contacts the top surface of the structure, such that the ladder rides on the arcuate outer edge of the upper portion as the ladder is pivoted from or to the in-use position.

In accordance with an aspect of the swim ladder assembly, the swim ladder assembly comprises two opposed side mounts with the swim ladder being mounted between the side mounts for rotation about the pivot axis, and/or wherein the swim ladder comprises two opposed side rails.

In accordance with an aspect of the swim ladder assembly, the side rail upper portion is formed from tubing, the upper portion comprising an arcuate handle defining the arcuate edge and having opposite ends, a pivot support bar connected at one of the ends of the arcuate handle and extending through the circle defined by the accurate edge, a front member extending from the other end of the handle, and a rear member extending from a forward end of the pivot support bar; the side rail pivot block being positioned along the pivot support bar; and the leg rail being depending from the front and rear members.

In accordance with an aspect of the swim ladder assembly, the rear member defines a dock support bar, the rear member being positioned such that, when the swim ladder is in the in-use position, the dock support bar extends generally vertically and is adjacent the side surface of the support.

In accordance with an aspect of the swim ladder assembly, wherein the side rail includes a cushioning stop positioned on said rear member to be between the side rail and the side surface of the structure when the swim ladder is in its in-use position.

In accordance with an aspect of the swim ladder assembly, the leg rail further comprises a front leg and a rear leg spaced behind the front leg; the at least one step being operatively connected to and extending between the front leg and the rear leg.

In accordance with an aspect of the swim ladder assembly, an upper most step of the at least one step is positioned to be generally level with the top surface of the structure when the swim ladder is in its in-use position.

In accordance with an aspect of the swim ladder assembly, said leg rail includes at least one step bracket which extends between the front and rear legs, the at least one step being secured to the bracket.

In accordance with an aspect of the swim ladder assembly, the side mount comprises a top member, a forward member extending downwardly from a forward end of the top member, and a rear member extending downwardly from a rear end of the top member. A brace extends between the rear member and the forward member, the brace preferably being positioned at a bottom of the rear member. Lastly, a bracket is adapted to mount the at least one side mount to the structure.

In accordance with an aspect of the swim ladder assembly, the bracket comprises at least one connector sized and shaped to mount the side mount to the structure.

In accordance with an aspect of the swim ladder assembly, the forward member of the side mount is sized to extend below the structure top surface when mounted to the structure.

In accordance with an aspect of the swim ladder assembly, the side mount pivot block includes a hole in an outer surface thereof and the side rail pivot block includes a hole in an outer surface thereof; the axle being generally cylindrical and having an outer surface and opposed ends. The axle comprises a locking hole formed in the outer surface of the axle and positioned to be aligned with the hole of one of the side mount pivot block and the side rail pivot block; at least two positioning holes formed in the outer surface of the axle and positioned to be aligned with the hole of the other of the side mount pivot block and the side rail pivot block; a locking member sized to be received in the locking hole to rotationally fix the axle relative to the one of the side mount pivot block and the side rail pivot block; and a positioning member removably receivable in a selected positioning hole. When the positioning member is engaged with a selected one of the at least two positioning holes, the swim ladder is rotationally fixed relative to the side mount, and, when the positioning member is disengaged from the at least two positioning holes, the swim ladder may be rotated relative to the side mount about the pivot axis.

In accordance with an aspect of the swim ladder assembly, the locking hole is positioned to be aligned with the hole of the side rail pivot block and the at least two positioning holes are positioned to be aligned with the hole of the side mount pivot block.

In accordance with an aspect of the swim ladder assembly, leg rail defines an angle with the vertical when the swim ladder is in its in-use position, such that a bottom of the leg rail is spaced forward from the pivot axis more than a top of the leg rail.

In accordance with an aspect of the swim ladder assembly, the angle defined by the leg rail is about 25°-35°, and preferably about 30°-33°.

In an embodiment, a swim ladder assembly, comprises a pair of opposed side mounts adapted to be secured to an upper surface of a structure, adjacent an edge of the structure and a swim ladder sized to fit between the opposed side mounts. The swim ladder comprises a pair of opposed side rails and a plurality of steps extending between the side rails; the side rails comprising an upper arcuate rail portion defining a radius R. Pairs of first and second pivot blocks, with one of the first and second pivot blocks positioned on the side mounts above a bottom of the side mounts by a distance approximately equal to the radius R; and a second pair of first and second pivot blocks is positioned on the side rails at the center of the circle defined by the arcuate rail portion. Each pivot block comprises an outer surface and opposed side surfaces, a passage extending through the pivot blocks to open at the side surfaces of the pivot blocks, and a hole extending from the outer surface of the pivot blocks to the passage. A pair of axles are shaped and sized to pass through the passages of both the first and second pivot blocks to rotatably mount the swim ladder between the side mounts. The axles are cylindrical and have an outer surface and opposed ends and comprise a locking hole formed in the outer surface of the axle positioned to be aligned with the hole of one of the first and second pivot blocks, at least two positioning holes formed in the outer surface of the axle and positioned to be aligned with the hole of the second pivot block and the side rail pivot block, a locking member sized engage the locking hole to rotationally fix the axle relative to the first pivot block; and a positioning member sized to removably engage the hole of the second pivot block. When the positioning member is engaged with a selected one of the at least two positioning holes, the swim ladder is rotationally fixed relative to the side mounts, and, when the positioning member is disengaged from the at least two positioning holes, the swim ladder may be rotated relative to the side mounts about a pivot axis.

In accordance with an aspect of the swim ladder assembly, the first pivot blocks are positioned on the side rails and the second pivot blocks are positioned on the side mounts.

### BRIEF DESCRIPTION OF THE DRAWINGS

FIG. 1 is a perspective view of the swim ladder assembly mounted to a dock with the swim ladder in an in-use orientation.

FIG. 2 is a perspective view of the swim ladder assembly mounted to the dock with the swim ladder in an out-of-use vertical orientation.

FIG. 3 is a perspective view of the swim ladder assembly mounted to the dock with the swim ladder in an out-of-use horizontal or stowed orientation.

FIG. 4 is a perspective view of the swim ladder assembly mounted to a dock showing the swim ladder in a series of superimposed orientations, from in-use to vertical to stowed, showing how each orientation proceeds from the one to the next via rotation about a pivot axis and showing that the arced railing at the top of the swim ladder defines a segment of a circle.

FIGS. 5A-E are front perspective, back perspective, side elevational, top pan, and front elevational views of the swim ladder assembly mounted to a dock and in the in-use position.

FIGS. 5F-G are enlarged fragmentary perspective views of the swim ladder when mounted to a dock.

FIG. 6 is an exploded perspective view of the swim ladder assembly and the dock.

FIG. 7 is an enlarged perspective view of the side mounts mounted to the dock.

FIG. 8A is a front perspective view of one of the side mounts, the two side mounts being mirror images of each other, without connectors and being provided with an optional panel;

FIG. 8B is a back perspective view of the side mount, but with connectors.

FIGS. 8C-D are top plan and bottom plan views, respectively, of the side mount with connectors.

FIGS. 9A-B are front perspective and side elevational views, respectively, of the swim ladder.

FIG. 10 is a bottom, rear perspective view of the swim ladder.

FIG. 11A is an enlarged, fragmentary top perspective view of the top portion of the swim ladder.

FIG. 11B is a horizontal cross-sectional view through the swim ladder taken along line B-B of FIG. 11A showing the underside of a step of the swim ladder.

FIG. 12A is an enlarged vertical cross-sectional view of the upper portion of the side rail of the swim ladder taken through a vertical plane.

FIG. 12B is a cross-sectional view of the handrail taken along line 12-12 of FIG. 12A showing a pivot axle received in the side rail about which the side rail pivots and which facilitates locking of the handrail in the various positions.

FIG. 13A is an enlarged cross-sectional view through the side rail and side mount taken along line 13-13 of FIG. 1 showing the pivotal mounting of the side rail, and hence the swim ladder, to the side mount;

FIG. 13B is a perspective view similar to FIG. 13A showing the connection between the side rail and side mount, with the side rail and side mount being in phantom, to better show the pivot blocks of the side rail and side mount.

FIG. 13C is an enlarged sectional view taken along the circle A of FIG. 13A to show the pivot blocks of the swim ladder and side mount and an axle extending through the pivot blocks.

FIG. 13D is an enlarged cross-sectional view of the axle, showing positioning holes of the axle.

FIG. 14A-B are top and bottom perspective views of a step of the swim ladder.

FIG. 14C is a perspective view of an alternative step for the swim ladder.

FIGS. 15A-C are front perspective, rear perspective, and rear elevational views, respectively, of an alternative embodiment of the side mount.

FIGS. 16A-B are cross-sectional views of the side mount of FIGS. 15A-B taken along lines A-A and B-B, respectively, of FIG. 15C.

FIG. 16C is a perspective view of the side mount of FIGS. 15A-C with the side mount frame in phantom to show the pivot axle and locking member of the side mount.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what we presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

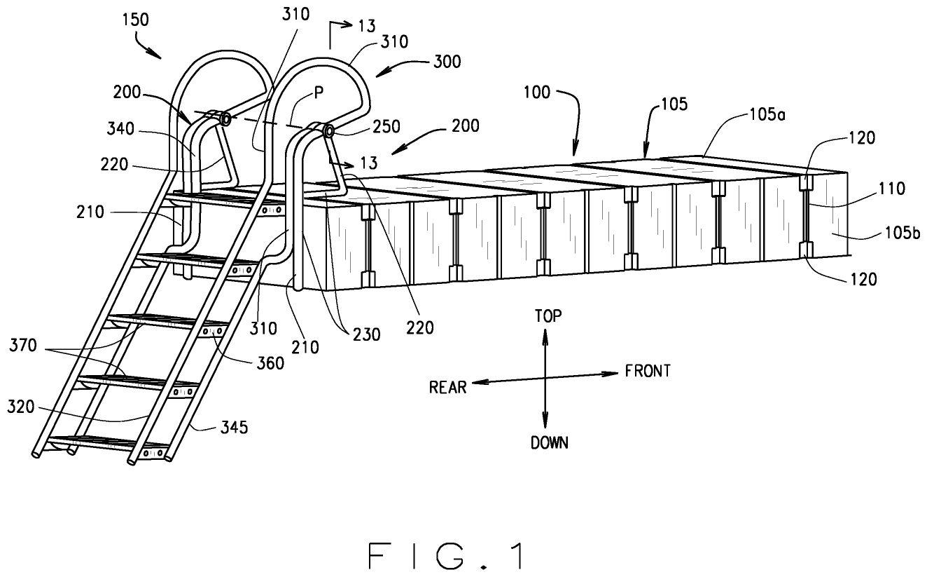

Turning initially to FIGS. 1-7, a dock module 100 is shown having a swim ladder assembly 150 mounted thereto. As used in this description, “up” or “top” and “down” or “bottom” refer to vertical directions relative to the dock module; “rear” or “rearwardly” refers to a direction along the dock module moving away from the ladder assembly 150; and “front” or “forwardly” refers to a direction moving along the dock module towards the ladder assembly. Stated differently, someone standing on the ladder assembly facing the dock module would be facing “rearwardly”. These directions are shown by the arrows in FIG. 1.

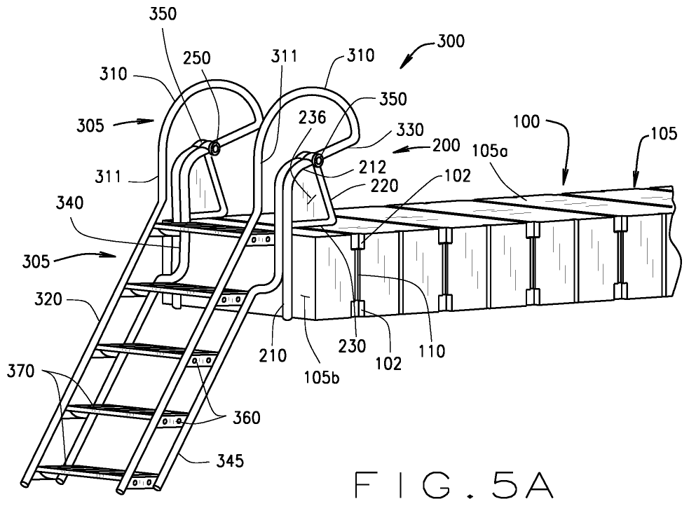

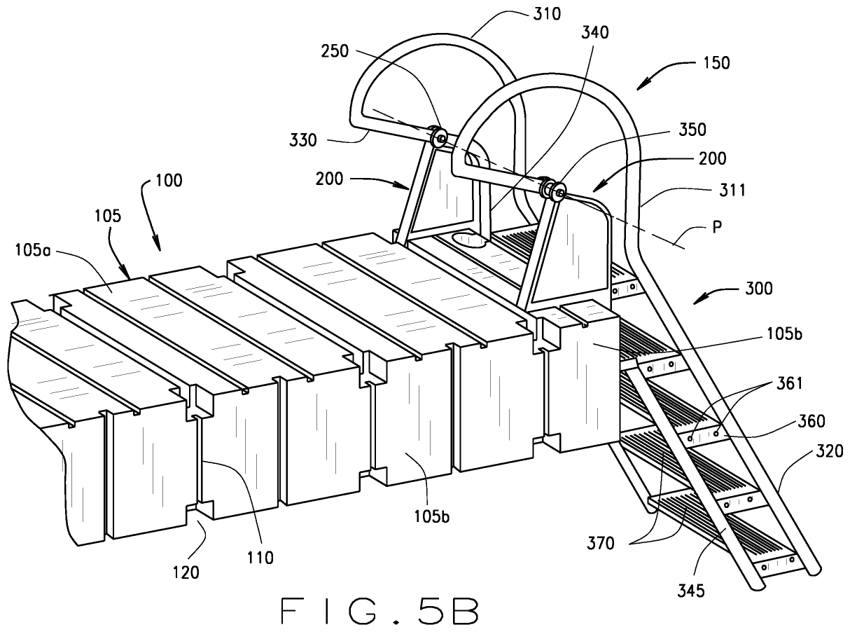

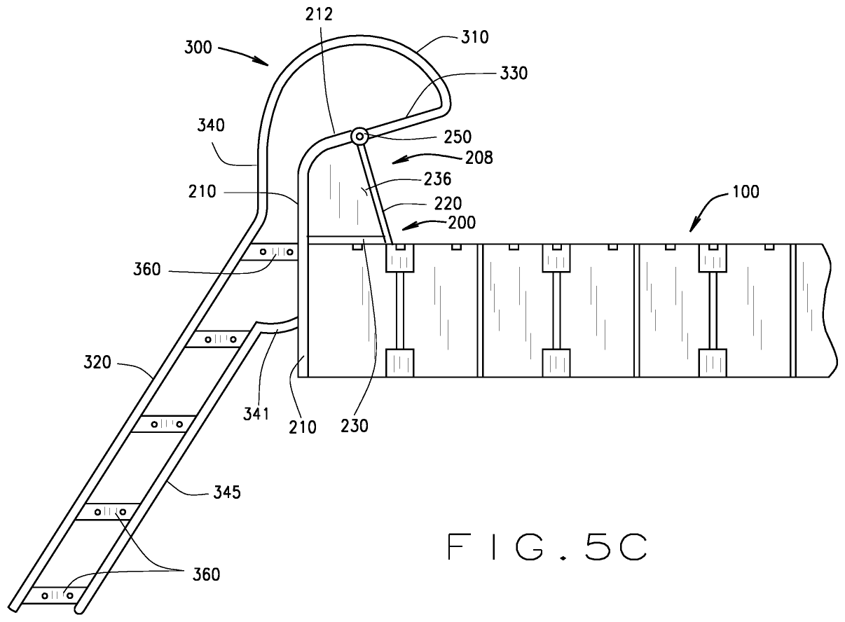

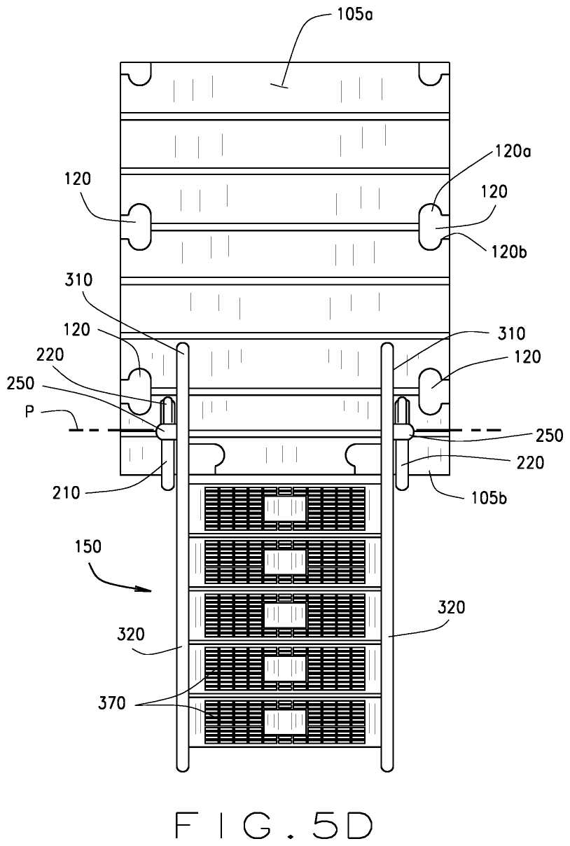

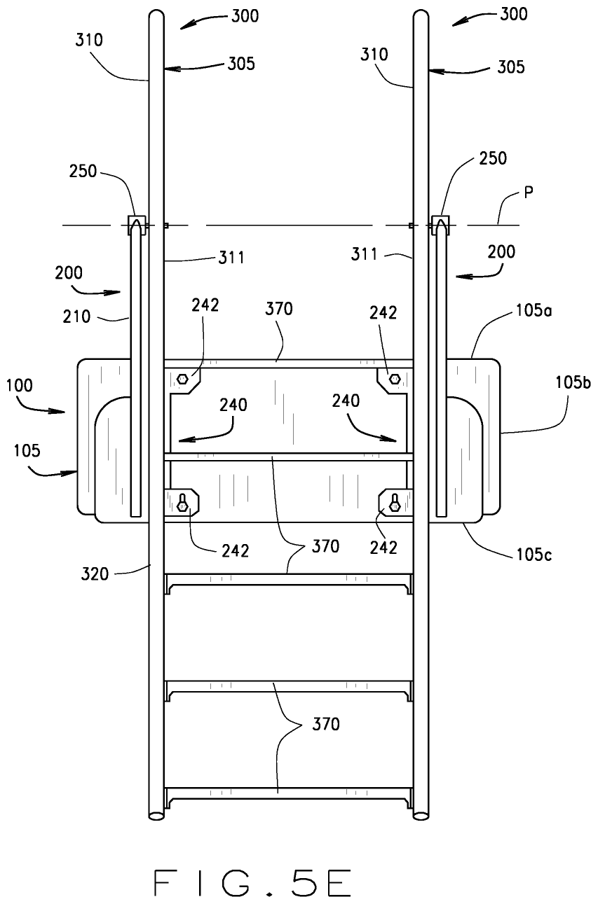

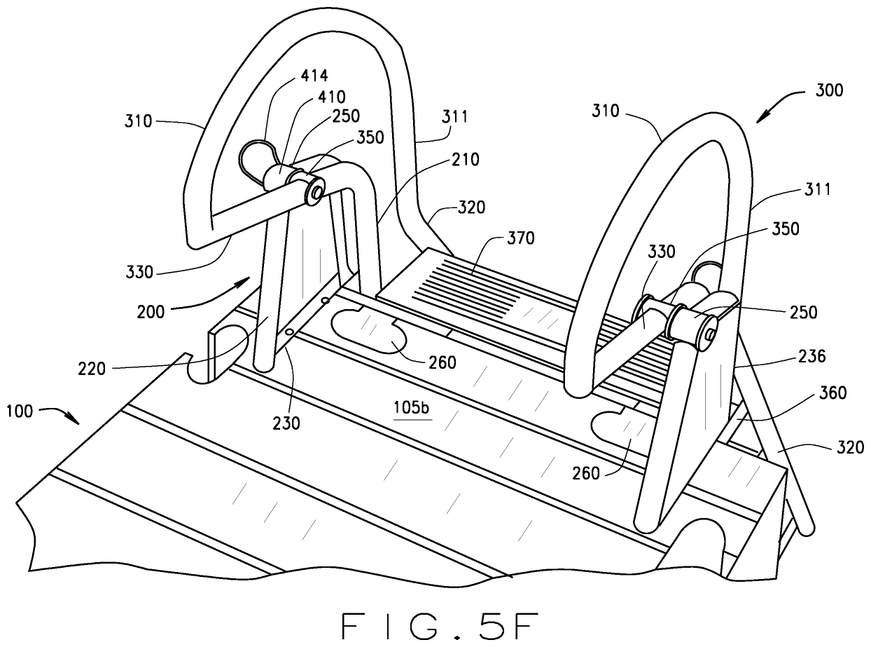

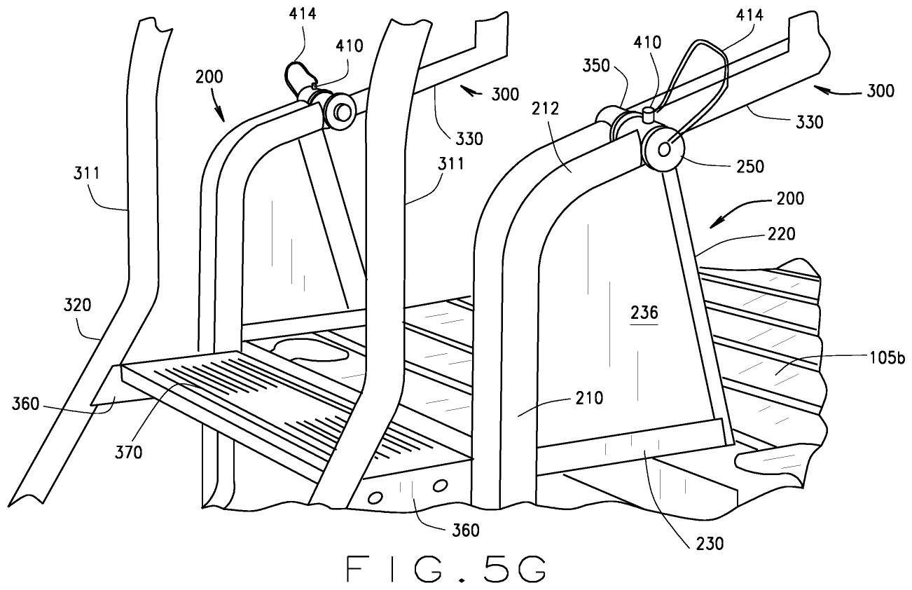

Although the swim ladder assembly 150 is described herein as being mounted to a dock module, it will be apparent that the swim ladder could be mounted to other structures, such as piers, rafts, and boats. The dock module 100, as shown, comprises a body 105 having a top, tread, surface 105a, side and end surfaces 105b, and a bottom surface 105c. The body 105 includes a plurality of upper and lower connector sockets 120 formed in the top and bottom surfaces which open to the sides and ends of the body. The upper and lower sockets are connected by channels 110 which extend vertically along the side and end surface of the body. As is known, the connector sockets 120 receive connectors to connect dock sections together or to mount accessories, such as the swim ladder assembly 150, to the dock module. As shown, the connector sockets 120 comprise an inner portion 120a (FIGS. 5D 7) and a narrower “neck” or entrance portion 120b which extends from the inner portion to the side or end surface of the dock module.

The swim ladder assembly 150 comprises a pair of opposed side mounts 200 which are mounted to the dock module 100 and a swim ladder 300 pivotally mounted between the side mounts.

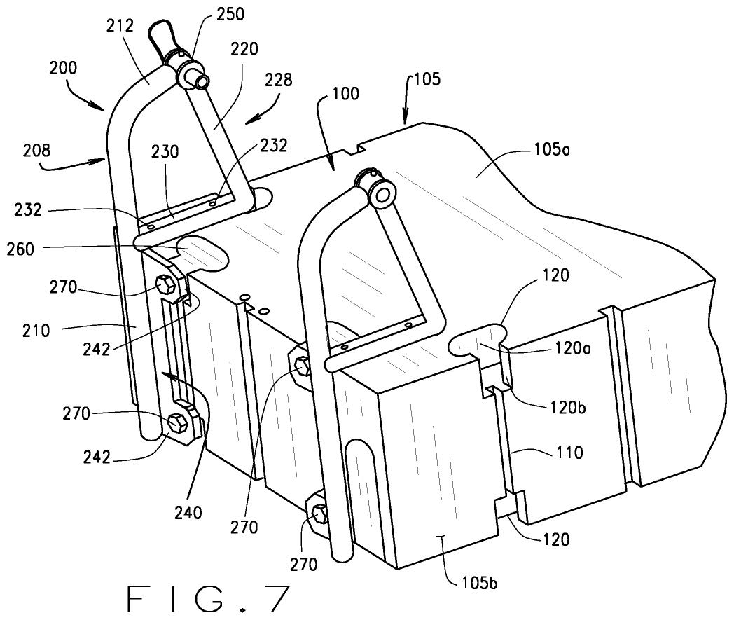

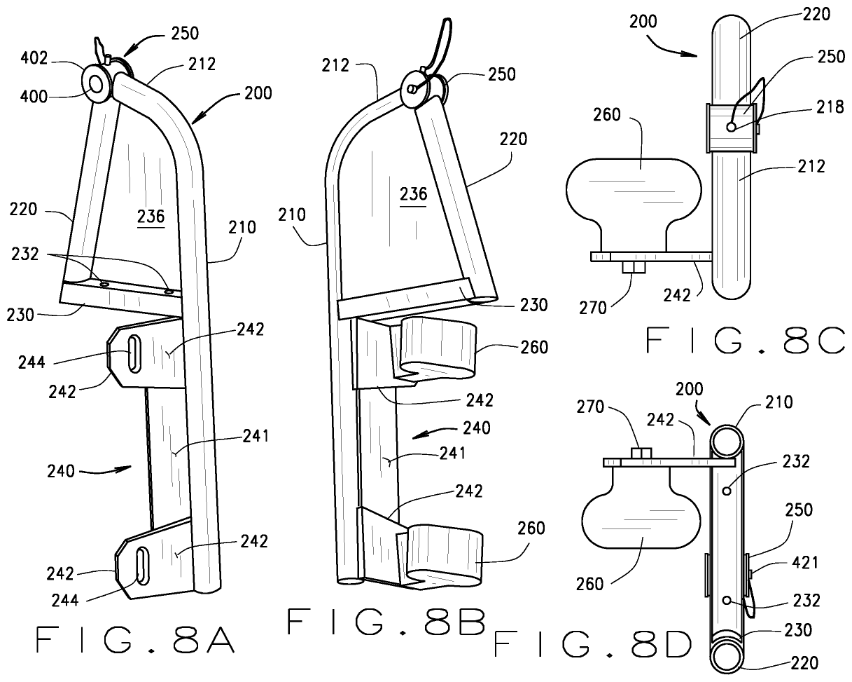

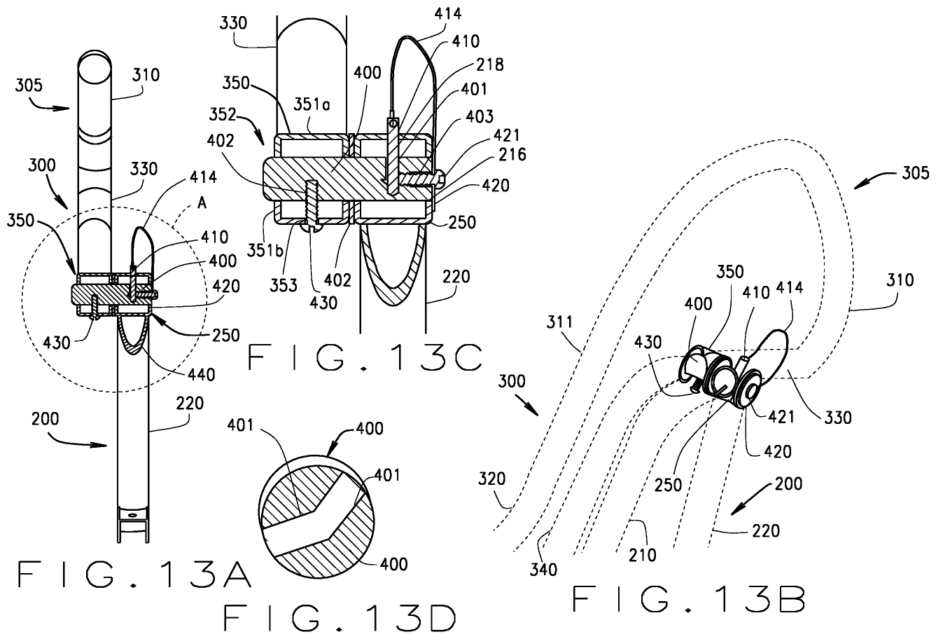

One embodiment of the side mounts 200, as best seen in FIGS. 7 and 8A-D, forms a frame 208 comprising a generally vertically extending rear member 210 and a top member 212 which extends forwardly from the top of the rear bar 210. Preferably, the rear member 210 and top member 212 are formed from a single member which is bent. A side mount pivot block 250 is mounted to the forward end of the top bar 212. The side mount pivot block 250 defines a, preferably, circular passage 216 (FIG. 13C) which extends horizontally through the side mount block and a pin hole 218 which extends radially though (and preferably from the top surface) of the side mount pivot block 250 to communicate with the passage 216.

A forward member 220 extends downwardly and slightly forwardly from the side mount pivot block 250 such that it defines an angle with respect to the axis of the rear, generally vertical member 210. The forward member 220 is shorter than the rear member 210 such that the bottom of the forward member 220 is between the top and bottom ends of the rear member 210. A horizontal brace 230 is fixed to, and extends between, the bottom of the forward member 220 and the rear member 210. As seen in the figures, the rear, top, and front members 210, 212, and 220 are shown as being formed from round bar or tube stock. However, the brace 230 is shown as being formed from square stock such that it has a flat upper and lower surfaces. Optional mounting holes 232 are formed in the top surface of the brace 230. As best seen in FIG. 7, the brace 230 extends generally horizontally and is generally perpendicular to the vertical member 210. When mounted to the dock module 100, the brace 230 will sit on the top surface 105a of the dock module, and the portion of the rear member 210 extending below the brace will extend along the front or side surface 105b of the dock module. The rear member 210, the top member 212, the forward member 220, and the brace 230 form the frame 208 which defines a top portion 228 of the side mount 200. As seen in FIG. 7, this frame 208 can be empty. However, as seen in FIGS. 5A-E, the frame 208 can be provided with a panel 236. This panel can be clear, translucent, or opaque. The panel 236 can be provided a logo (such as a manufacturer logo or the logo of an establishment (i.e., of a marina, campground) where the swim ladder assembly is installed. Other information (such as an address) could also be applied to the panel.

A bracket 240 is connected to the lower end of the rear vertical bar 210 below (and preferably immediately below) the horizontal brace 230. The bracket 240 provides a primary means of connection of the side mount 200 to the dock module 100. Preferably, the bracket 240 extends generally perpendicularly to the plane defined by the top portion 228 of the side mount 200 such that the top portion 208 of the side mount 200 will be generally perpendicular to the edge of the dock module 100. As seen in FIG. 7, the bracket 240 can have an overall (top-to-bottom) length about equal to the top-to-bottom depth of the dock module 100. The length of the bracket is, in part determined by the means of connection of the side mount to the structure. If the connector sockets were differently positioned or shaped, the length of the bracket could vary from that shown in the figures. The bracket 240 is mounted to the ream member 210 such that the brackets of the two side mounts extend toward each other. The brackets could, alternatively, be mounted to the rear member 210 to extend away from each other.

Turning to FIGS. 8A-B, the bracket 240 comprises a central plate 241 which extends between upper and lower end pieces 242. The upper edge of the upper end piece and the lower edge of the lower end piece are generally horizontal, and generally define right angles with the rear member 210. The outer vertical edges of the central plate 241 and the upper and lower pieces 242 are generally collinear, and are secured to the rear member 210. The end pieces 242 of the bracket each extend beyond an inner edge of the central plate 241. However, if desired, the bracket 240 could be formed as a single plate. A vertically extending elongate opening, aperture, or hole 244 is formed in each of the bracket end pieces proximate free ends of the end pieces.

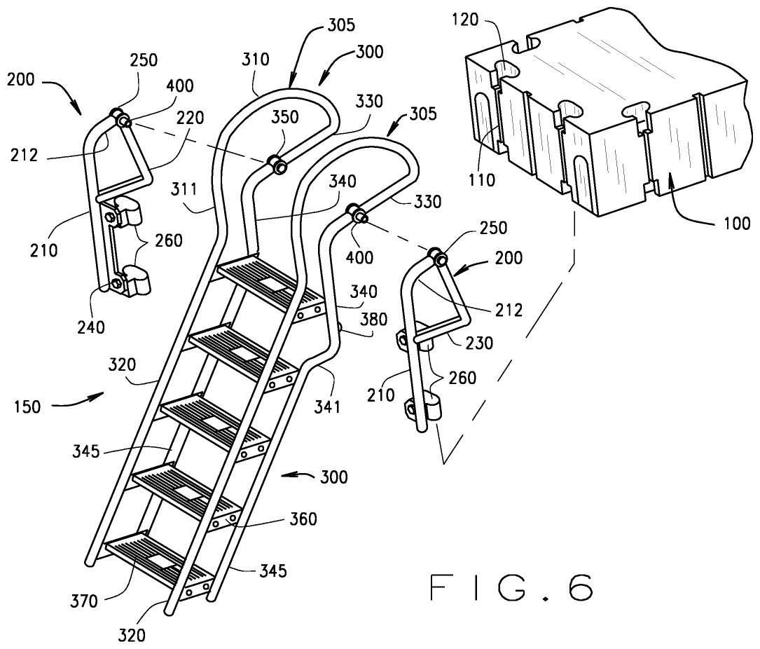

Connectors 260 are secured (or are securable) to the upper and lower end pieces 242 by way of a fastener 270 (such as a screw or bolt) that extends through the aperture 244 in each end piece 242 of the bracket 240 into an end surface of the connector 260. Alternatively, the fastener can extend from the end surface of the connector to pass through the bracket aperture 244, and can be secured in place with a nut. As noted, the bracket aperture 244 is formed as an elongate slot. This provides or accounts for slight variations in relative positions of the top and bottom connector sockets 120 relative to each other. As shown in FIGS. 6 and 7, the connectors 260 are shaped complimentarily to the sockets 120 of the structure. The shape of the connectors 260 and sockets 120 allow for the connectors to be inserted vertically (from the top or bottom) into the sockets but to substantially prevent horizontal movement of the connector, so that the connector cannot be pulled forwardly from the socket 120. The connector 260 preferably is formed as described in U.S. Pat. No. 5,281,055, which is incorporated herein by reference. However, the connector can also be formed as described in U.S. Pat. Nos. 7,243,608, 9,051,953, or 9079641, all of which are incorporated herein by reference. Any other connector configuration could be used as well. As can be appreciated, if different connectors are used, the shape of the connector sockets 120 of the dock module would change as well. Once inserted in the dock module sockets, the brackets 240 can be affixed to the connectors by means of the fastener 270, or any other affixation known to those of ordinary skill in the art. In this way, secure attachment of the side mounts 200 to the dock module can be created, enabling further secure attachment of the swim ladder.

The side mounts 200 can be connected to the dock module using fasteners, such as bolts or screws, rather than the connectors 260. In this instance, fasteners extend through the holes 232 in the brace 230 to be received in the top surface of the structure and through the apertures 244 in the brackets to be received in the side or end surface of the structure. If the structure is shorter than the distance between bracket end pieces, additional fastener holes could be provided in the bracket center plate 241, Thus, the fastener holes 232 in the brace and apertures 244 in the bracket enable the side mounts to be mounted to a dock (or other structure) which does not have connector sockets.

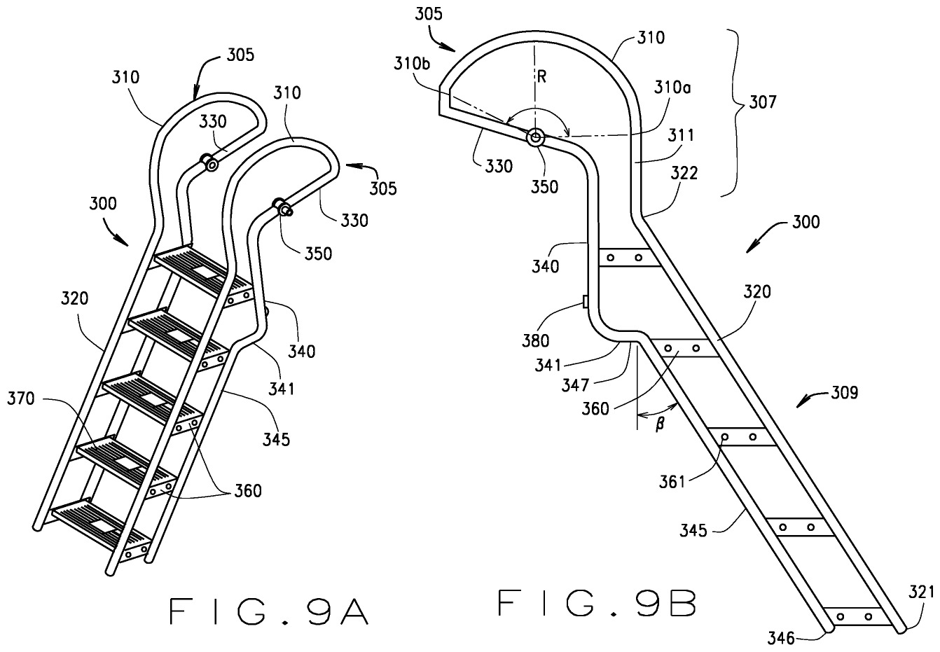

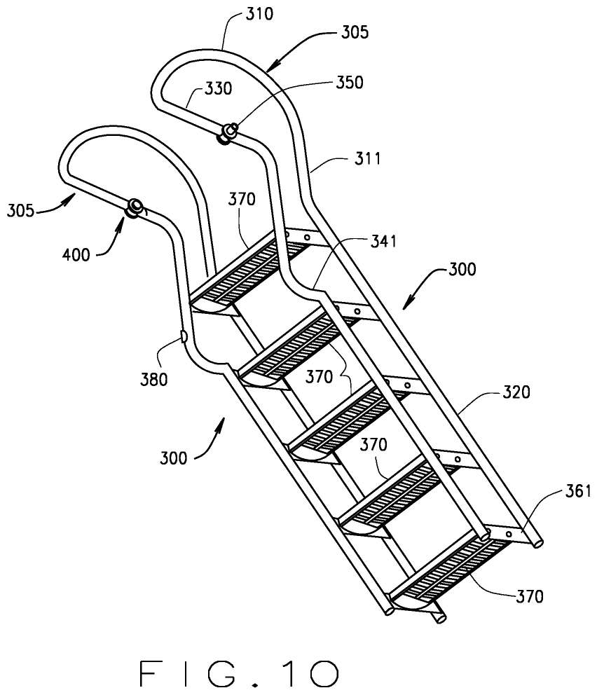

Turning to FIGS. 9A-B, the swim ladder 300, as shown, comprises opposed side rails 305 between which steps or rungs 370 extend. The side rails 305 each comprise an upper portion 307 from which a leg rail 309 extends.

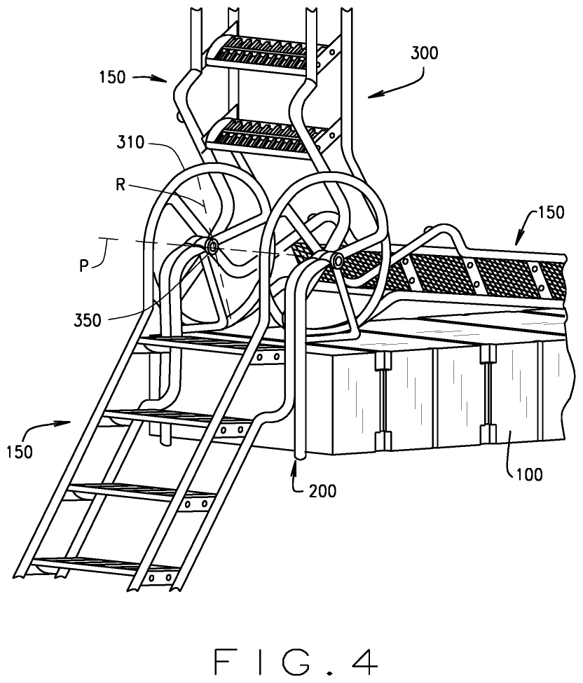

The upper portion 307 is shown as being formed from tube or bar stock and includes an arcuate handle 310 having front and back ends 310a,b forming an arc defining a radius R. As seen in FIG. 4, the radius R is generally equal to the distance between the pivot block 250 of the side mount 200 and either the bottom of the side mount brace 230 or the dock module tread surface 105a. The arc of the handle 310 defines a portion of a circle, and the angle defied by the arc is at least 90° and preferably less than 270°. For example, the arc can define an angle α of at least 100°, 110°, 120°, 130°, 140°, 150°, or 160° and is preferably less than 250°, 230°, or 200°, and more preferably no greater than 180°. In a preferred embodiment, the angle α can be about 150° to about 160°.

A substantially linear vertical handle portion 311 extends downwardly from the rear end 310a of the arcuate handle 310. This vertical portion 311 and the arcuate portion 310 generally define an upper handrail for the swim ladder 300. A pivot support bar 330 extends rearwardly from the front end 310b of the arcuate handle portion 310. The pivot support bar 330 is angled slightly downwardly relative to the horizontal to be generally parallel to the top bar 212 of the side mounts 200 when in the in-use orientation, as can be seen in FIG. 5A. A side rail pivot block 350 is positioned along the pivot support bar 330. Lastly, a dock support bar 340 extends downwardly from the rear end of the pivot support bar 330 and extends generally parallel to the vertical portion 311, but is spaced forwardly thereof. The dock support bar 340 is sized and shaped to provide structural support to the swim ladder when in an “in-use” orientation by pressing against a vertical surface of a dock, boat, or other structure, as seen in FIGS. 1, 4 and 5A. As seen in FIG. 1, the dock support bar 340 is shown to have a length less than the height of the dock module and extend to a point at least halfway down the side surface of the dock member. However, the dock support bars 340 could be longer (or shorter) if desired. Preferentially, at its bottom, the dock support bar curves and terminates in a short horizontal segment 341. The dock support bar 340 can be provided with stops 380 (FIG. 9B) which make direct, cushioning contact with the side or end surface of the dock module 100 to which the ladder assembly is mounted, and thereby protect the dock module from wear and tear due to friction and intermittent collisions with the swim ladder.

The leg rail 309 is also shown as being formed from tube or bar stock and includes a rear ladder leg 320 extending from the end of the vertical portion 311 and a front ladder leg 345 extending from the rear end of the horizontal segment 341 of the dock support bar. The front and rear ladder legs are preferably linear (or straight), and are generally parallel to each other. The front and rear ladder legs extend at an angle ß to the vertical of about 25°-35°, and preferably about 30°-33°, such that their bottom ends 321, 346 (FIG. 9B) are at a farther horizontal distance from the arcuate handles than their top ends 322, 347. The angle was selected so that that the ladder is more stair like. The angle ß selected is also one which pets, such as dogs, can climb. The front ladder leg 345 is shorter than the rear ladder leg 320, such that the bottom 346 of the front ladder leg is generally at the same vertical position as the bottom 321 of the rear ladder leg. As can be appreciated, the legs are sized such that they will be at water level or, preferably, submerged below water during use.

The side rails 305, as noted, are preferably formed from metal tubing, such as aluminum tubing. The side rails can be formed in sections which are welded or otherwise securely joined together. For example, the arcuate handle 310, the vertical support bar 311, and the rear ladder leg 320 can be formed from a single tube by a bending operation. Similarly, the pivot bar 330, the dock support bar 340, and the terminal end 341 of the dock support bar can be formed from a single tube by a bending operation. Through various bending and joining operations, the side rails could be formed from more or fewer sections. Further, as can be seen, the front and rear ladder legs 320, 345, in conjunction form a leg rail.

Although the side rail upper portion 307 is shown as being formed from bar or tube stock, the side rail upper portion could be formed as a panel that is solid or has perforations or slots. Of importance is that the top edge or surface of the upper portion define the arc have the radius R, as described above, and that the side rail pivot block 350 be positioned along the pivot support bar 330 at the center of the circle defined by the arc. Similarly, the leg rail 309 could be formed from a panel and be continuous from front to back (with or without perforations, slots, etc.). If the side rail 305 is formed from panels, the upper portion 307 and leg rail 309 could be latticed. If the leg rail were formed from other than two spaced apart tube sections, the steps or rungs 370 could be secured directly to the leg rails, thereby omitting the need for the step brackets 360 (described below). As can be appreciated, perforations, lattices, slots, etc. in the upper portion and leg rail would reduce weight and increase visibility to the sides while the ladder is in use.

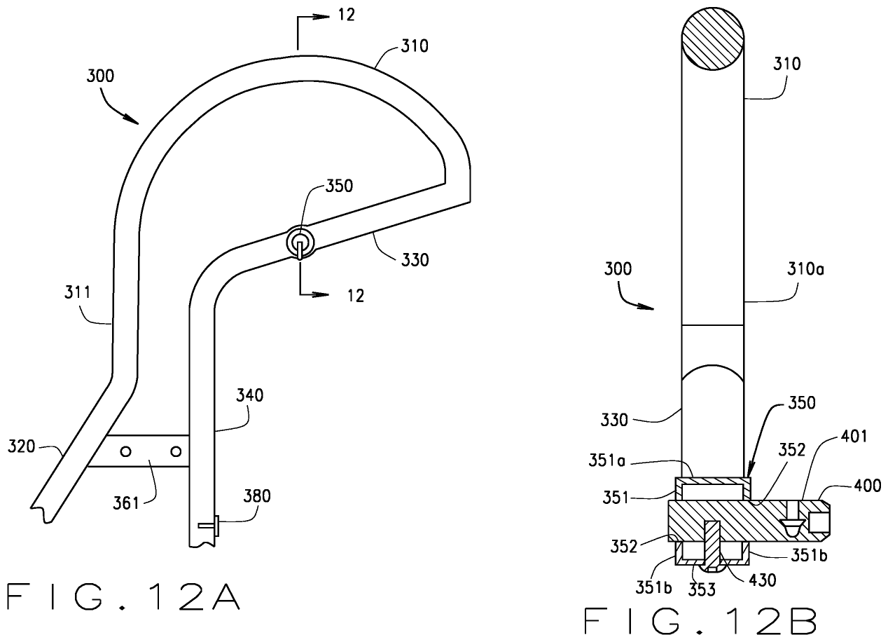

Turning to FIGS. 12A-B and 13A-D, the side rail pivot block 350 is substantially hollow comprising an outer surface 351a and side walls 351b. The outer surface is shown to be generally cylindrical, but could be formed in other shapes. The side walls 351b define opposed holes 352, and a hole 353 is formed in the outer surface 351a. The hole 353 is shown to be on the bottom of the outer surface, but could be located elsewhere along the outer surface of the side rail pivot block 350. The holes 352 and 353 open to the interior of the side rail pivot block. The side rail pivot block 350 is positioned on the pivot support bar 330 to be substantially at a center of a circle defined by the arc of the arcuate handle 310. The pivot support bar 330 thus extends through the center of the circle defined by the arc of the handrail.

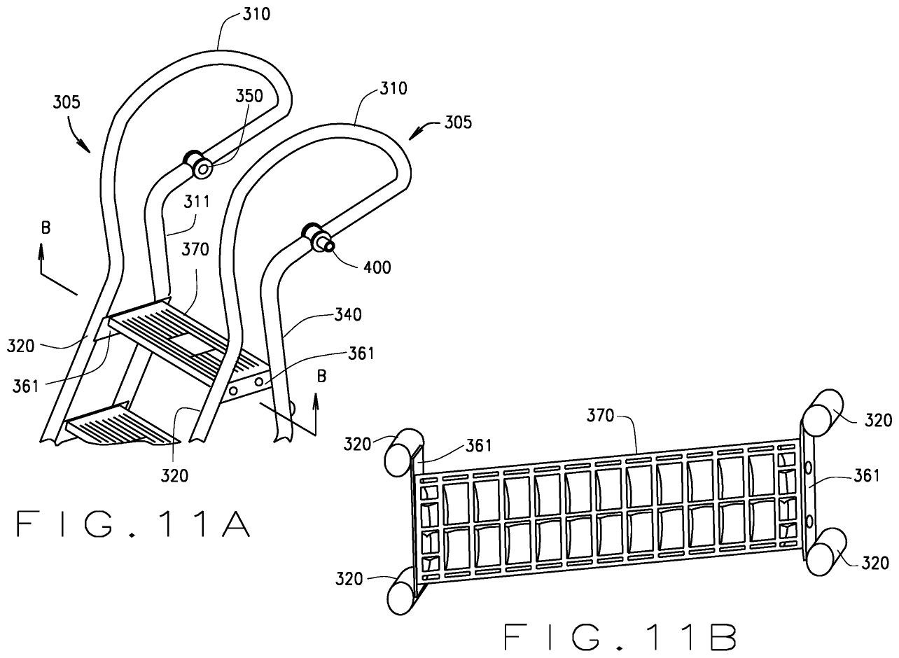

The swim ladder 300 is pivotally mounted to the side mounts 200 via pins or axles 400 that extend through the side mount pivot block 350 and the side rail pivot block 250, there being an axle 400 for each side rail/side mount pair. If desired, a washer or spacer 402 (FIG. 11C) can be positioned about the axle 400 between the side rail pivot block 350 and the side mount pivot block 250. This washer can be made from a material that will reduce friction between the two pivot blocks to facilitate pivoting of the ladder. As seen most clearly in FIGS. 13B, C, a cap 420 is mounted to an outer end of the axle 400 via a screw or bolt 421 passing into a threaded hole 403 in the end of the axle 400. As seen, the cap 420 is adjacent a side surface of the side mount pivot block 250. The cap 420 has a diameter greater than the hole in the pivot block 250 through which the axle 400 extends to thereby prevent the axle from passing too far through the pivot blocks 250 and 350.

The axle 400 has a series of radially extending positioning holes 401 proximate one end of the axle and a lock hole 402 proximate the opposite end of the axle. As seen in FIG. 13D, the axle 400 comprises two holes 401 which intersect in at an approximate center of the axle. More positioning holes could be provided if desired. As shown, the lock hole 402 is located near the end of the axle closest to the side rail pivot block 350 and is positioned to be alignable with the hole 353 in the outer surface 351a of the side rail pivot block 350. A locking member 430 (preferably in the form of a threaded fastener, such as a screw, bolt or the like) passes through the hole 353 of the side rail pivot block 350 into the axle hole 402 to thereby rotationally fix the axle 400 relative to the side rail. As can be appreciated, the locking member 430 and the cap 420 will act in concert to positionally fix the axle 400 axially with respect to the pivot blocks 250, 350, and thereby prevent the axle from moving axially relative of the pivot blocks in any substantial amount. Although a locking member is shown as being a screw or bolt, any other mechanism to rotationally fix the axle 400 relative to the side rail pivot block could be used. For example, a spring mounted ball could be used. Alternatively, the axial passage through the side rail pivot mount could define a square, or other polygonal shape, and the portion of the axle which passes through the side rail pivot block could have the same shape.

The positioning holes 401 are shown to be positioned circumferentially about the axle's cylindrical wall to be inside of the side mount pivot block 250 to be aligned with the pin hole 218 in the side mount pivot block 250. The positioning holes 401 are sized and shaped to removably receive a positioning member 410, shown to be a pin. All the positioning holes 401 are located along a single circular curve around the axle's cylindrical wall, as shown in cross-section in FIG. 13D. Preferably, the positioning holes 401 are spaced about the axle 400, such that the angles defined by each positioning hole relative to the fastener hole correspond to the angles defined by rotation of the swim ladder to each predefined orientation. As can be appreciated, when the positioning member 410 is in an engaged position (as shown in FIGS. 13A, B), the ladder 300 is prevented from rotating relative to the side mounts 200. However, when the positioning member 410 is removed, the ladder can be rotated relative to the side mounts between its various positions. Preferably, the positioning member/pin 410 is tethered to the side mount pivot block 250 by a tether 414 which connects the pin to the end cap 420. If desired, the tether could be omitted. Preferably, the positioning pin 410 is manufactured to be sufficiently strong to resist ordinary shear forces from attempted rotation of the swim ladder without snapping. The positioning member 410 may alternatively comprise a spring ball to increase friction between the pin and positioning hole 401 and thereby improve retention of the pin in the positioning hole 401. The placement of the positioning holes 401 and the locking pin hole 402 could be reversed, if desired, such that the locking pin hole is aligned with the hole 218 in the side mount pivot block 250 and the positioning pin holes 401 are aligned with the hole 353 in the outer surface of the ladder rail pivot block 350.

The axle 400 is shown to extend beyond the inner side surface of the side rail pivot block 350. That is, the axle 400 has a length greater than the combined widths of the two pivot blocks. If desired, a seal, such as an O-ring could be positioned on the free end of the axle (i.e., the end opposite the end cap 420) to reduce the potential for water from entering the tubes from which the side rails 305 are formed. Similarly, the end cap could seal against the outer side surface of the side mount block to reduce the potential for water from entering the tubes from which the side mounts 200 are formed. Finally, a positioning ring (such as an e-clip) could be used to further axially fix the axle 400 in place relative to the pivot blocks 250, 350.

Turning to FIG. 9b, the step brackets 360 comprise flat plates to which steps or rungs 370 are attached. As shown, a top step bracket extends between the dock support bar 340 and the rear ladder leg 320, and the remainder of the step brackets extend between the rear ladder leg 320 and the front ladder leg 345. The step brackets can be secured to the side rails 305 by any desired means. As can be appreciated, the step brackets will help maintain the position of the front and back portions (i.e., the front and rear legs) of the side rails relative to each other. The step brackets are positioned such that the top edges of the brackets are generally horizontal when the ladder is in its in use position. The step brackets are shown to be quadrilateral, with the front and back edges of the brackets formed to correspond to the slope or angle of the rail sections to which they are connected. Preferentially, the step brackets comprise regularly spaced holes for receiving fasteners 361 to secure the steps to the step brackets.

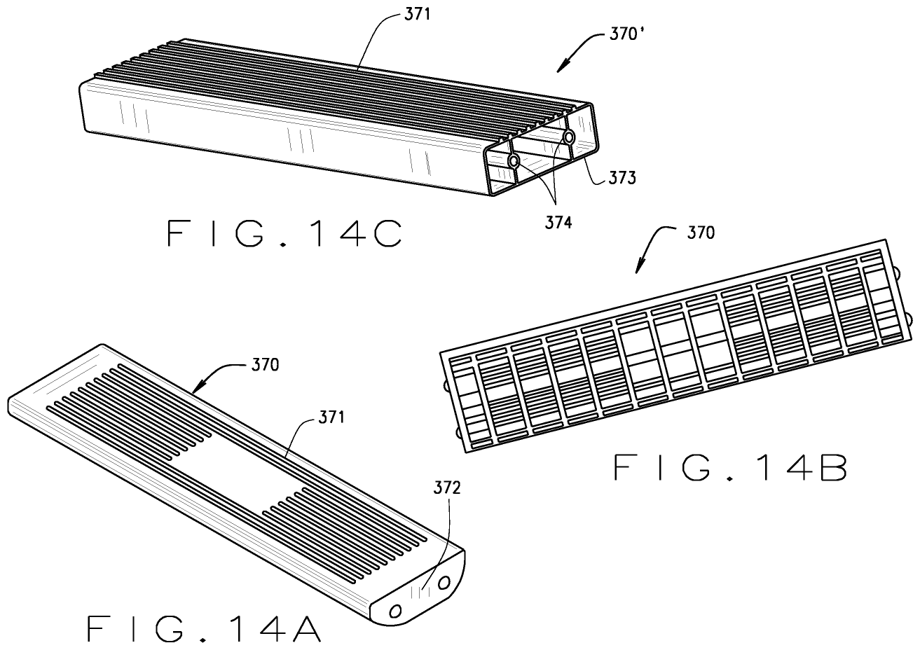

As can be appreciated, the step brackets are mounted to the opposed side rails to define pairs of left and right brackets that are generally co-planar with each other. Steps 370 are secured between the opposed plates of a pair of step brackets 360, such that the steps 370 will be generally horizontal when the ladder is in its in-use position. As seen in FIG. 14A, the steps define an upper, preferably, flat tread surface 371, a bottom 373, and opposed sides 372. The opposed sides include bolt holes 373 (FIG. 14C) through which the fasteners 361 pass to secure the steps to the step brackets 360. The steps 370 can be substantially rectangular prisms, as shown in FIG. 14C, or can have curved bottom surfaces, as shown in FIGS. 14A, B, although individual faces may be made concave or convex. In another form, the steps 370 can be generally rectangular, but comprise top, front, and back walls (and not have a bottom surface). Additionally, the steps 370 can have side surfaces, as seen in FIG. 14A, or can have open sides, as seen in FIG. 4C. In either event, the stairs 370 are provided with, preferably, threaded holes 374 at its opposite sides to receive fasteners 361. Preferably, the uppermost face or tread surface 371 is flat and defines a tread pattern to reduce the potential for the tread surface to be slippery. To this end, tread surface may comprise a pattern of parallel bars, elevated mesh molding, or any other pattern known to generate a rough surface more amenable to minimizing the slipperiness of the tread surface.

As seen in FIGS. 1, 4, and 5A-G, the steps 370 (and step brackets 360) are positioned on the side rails 305 such that the upper most step will be generally level with the upper surface 105a of the dock member (or structure to which the step ladder assembly is mounted) when the ladder is in its in-use position. Thus, when a someone is ascending or descending the ladder, when they are level with the end surface of the dock member (e.g., on the step below the top step), their feet will be spaced from the end surface of the dock member, to reduce the potential of their stubbing toes the end surface of the dock member.

During operation of the swim ladder apparatus, the user is able to rotate the swim ladder about a pivot axis P (FIGS. 1, 5B, 5D, and 5E) defined by the axles 400 and lock it into one of a plurality of predefined orientations by means of the positioning member 410. This is exemplified in each of FIGS. 1-3 as well as the depiction of FIG. 4, which shows three superimposed predefined orientations for the swim ladder. As seen in FIGS. 1-3 and 5A-E, the pivot blocks 250, 350, and thus the pivot axis P are spaced rearwardly from the edge of the dock and is spaced above the surface of the dock. For example, the pivot axis could be about 5″-10″ from the edge of the dock member and about 12″-18″ above the surface of the dock member. Further, a substantial portion of the rail section 310 is located over the dock. Thus, to pivot the ladder 300, a user does not have to reach out over the edge of the dock to pivot the ladder up. Further, because a substantial portion of the rail section 310 and the pivot support bar 330 are behind the pivot axis P, a user can push down on the rail section 310 to start pivoting of the ladder. This downward pushing motion makes operation of the swim ladder easier than that of currently available pivoting swim ladders which do not provide for such lever action.

Further, when the ladder is in the lowered, in-use position, the angle of the rail section 309 results in the user being farther from the pivot axis P when the user is standing on one of the steps than most commercially available pivoting swim ladders. This increases the torque generated when a swimmer uses the ladder, which will increase the force or pressure of the ladder against the dock, thereby reducing movement of the ladder relative to the dock during use. This effect is further enhanced by the fact that the pivot axis P is raised and spaced rearwardly from the edge of the dock.

When in the in-use orientation, shown in FIG. 1, the user can ascend or descend the ladder as desired. The swim ladder is locked in this orientation by the engagement of the positioning member 410 with the available positioning hole 401 in axle 400. The ladder is also held in place, in part, by gravity. Thus, the use of the positioning member 410 could be omitted when the ladder is in its in-use orientation. However, the pin will help fix the ladder positionally relative to the side mounts and dock module. Thus, use of the positioning member 410 when the ladder is in the in-use orientation will reduce the potential for the ladder to pivot during use (i.e., when someone is climbing the ladder), and will reduce the potential for the ladder to pivot due to motion of the water. Thus, use of the positioning members will help reduce repetitive impacts of the ladder (or ladder stops 380) against the dock module 100. When the user wishes to rotate the swim ladder, they disengage the positioning member 410 from the positioning hole 401 (i.e., pull out the pin), which permits the ladder to be rotated about the pivot axis P. Note that the axles 400 are positionally fixed relative to the ladder rail. Thus, as the ladder 300 is rotated, the axle 400 will rotate within the side mount pivot block 250.

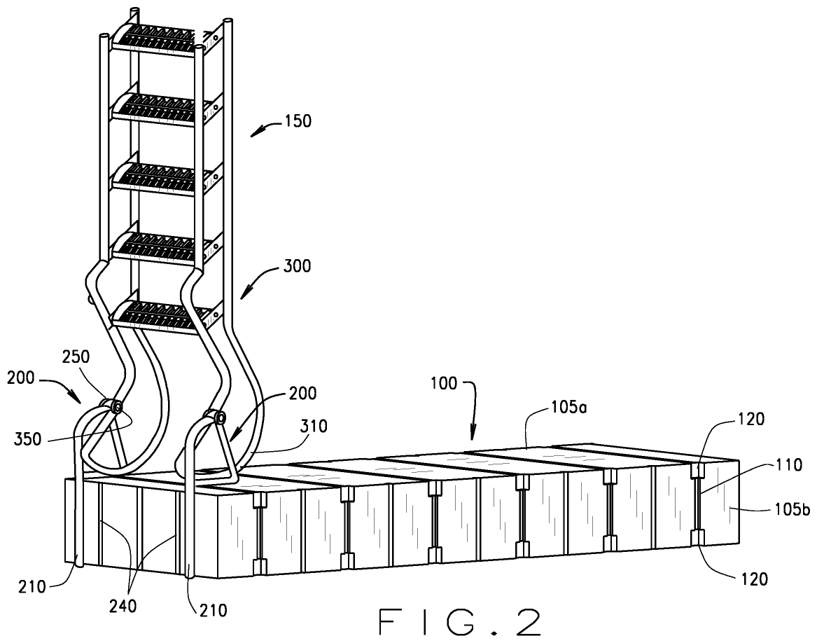

Once the swim ladder is brought to a vertical orientation as depicted in FIG. 2, the user can lock the swim ladder in place by re-engaging the positioning member 410 with a selected positioning hole 401 (i.e., reinsert the pin). At this position, the axle will have been rotated sufficiently to bring another positioning hole 401 in line with the positioning hole 218 in the side mount pivot block 250. Thus, the pin 410 can be passed through the side mount pivot block 250 and be received by another positioning hole 401. Note that in FIG. 2, the vertical orientation of the swim ladder 300 coincides with rotation of the arcuate handles 310 such that the uppermost portion of the handrails are now in contact with, or close to, the upper surface 105a of the dock. By engaging the dock surface 105a, the weight of the swim ladder 300 is redistributed through the arcuate handles and into the dock module, thereby relieving stresses and strains that might otherwise be applied to the axles 400, and the side mounts 200.

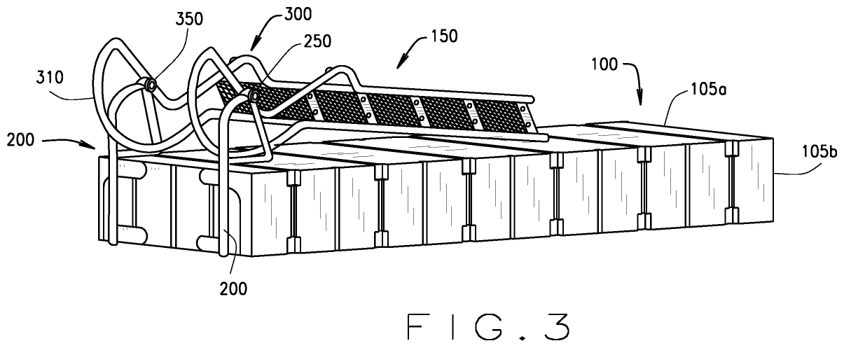

Using the same method described above of removing the positioning pin 410, the swim ladder 300 can be further rotated about the axle 400 until it is in a final position, stowed, as shown in FIG. 3. Once in this orientation, the axle will be so rotated that a third positioning hole 401 in the axle is aligned the positioning hole in the side mount pivot block, and the tethered pin 410 can inserted through the outer surface of the pivot block into pin hole to lock the swim ladder 300 into this third position. As noted with the in-use orientation, gravity can be relied upon to maintain the ladder 300 in the stowed position. However, use of the positioning pin will prevent the ladder from “bouncing” relative to the dock, and will thus reduce the potential for repetitive impacts of the ladder with the dock upper surface 105a. Note again that the arcuate handles of the swim ladder provide support to distribute the weight of the swim ladder more evenly.

In alternative swim ladders such as those containing only a single ladder leg 320 or 345, the step brackets 360 may be affixed to the ladder leg at one end of the step bracket or anywhere along the length of the step bracket. In some alternatives, the step brackets may be defined entirely as the side surfaces 372 of the steps 370 themselves.

A spring pin may take the place of the tethered pin 410 or the pin 430, or both. The ladder pivot block 350 and axle 400 may form a single integrated piece rather than using a pin 430 to lock their orientations with respect to one another. Alternately, the relative locations of the pin 430, the tethered pin 410, and the holes in the axis 400 may be reversed, such that axle 400 may be rotationally fixed with respect to the side mount pivot block 250 rather than being in fixed with respect to the side rail pivot block 350. In a similar arrangement, the side mount pivot block 250 and axle 400 may form a single integrated piece, and the plurality of holes 401, tethered pin 410, plate 420 and threaded fastener 421 may instead be present on the ladder pivot block 350.

Three orientations of the swim ladder 300 are described, corresponding to three positioning holes 401 in the axle 400. However, the axle may comprise more or fewer than three positioning holes 401, and thus, the ladder 300 may be adjustable to more or fewer than three orientations.

In another alternative, the linear vertical portion 311 of the swim ladder 300 may be omitted, and the arcuate handles 310 may directly connect to the rear ladder legs at second end 322.

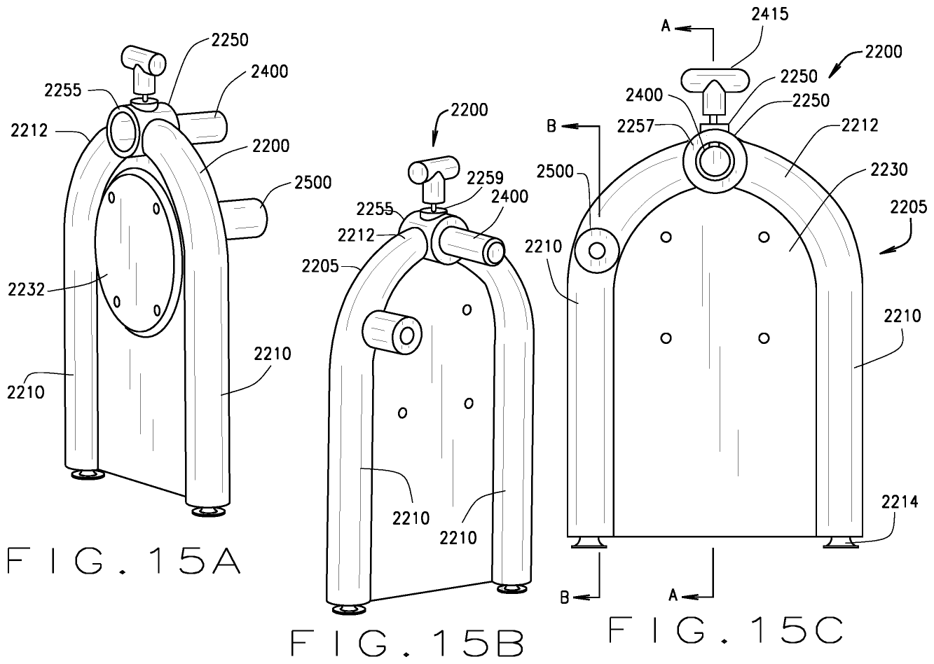

An alternative configuration of the side mounts is shown in FIGS. 15A-C and 16A-C. The side mounts 2200 include a generally U-shaped frame 2205 comprising two vertical legs 2210 joined at the tops ends by a semicircular top member 2212. The side mounts 2200 are constructed to be mounted to the upper surface of the dock, and thus are not dependent upon connectors and connector sockets to secure the side mounts 2200 to the dock. Connection to such the dock may be by means of threaded fasteners 2214 (such as screws or bolts) which are received in threaded apertures/passages 2216 extending upwardly into the legs 2210 from the bottoms thereof. The threaded fasteners are secured to the surface of the dock. They can, for example, be passed through holes in the upper surface of the dock or be embedded in the dock. If desired, one of the legs 2210 could be longer and extend over the edge of the dock. In this case, the longer leg could have a bracket (such as bracket 240) fixed thereto, to enable the side mounts 2200 to also be secured to the side or end surface of the dock.

A solid panel 2230 can fill the space defined by the U-shaped frame 2205. A plaque 2232 can be mounted to the panel 2230. This plaque can be provided with a manufacturer logo or other identifying information (such as a dock number or address).

A side mount pivot block 2250 is positioned at the apex of the semicircular top member 2212. In this instance, the frame 2205 could be formed from two pieces which are fixed to opposite sides of the side mount pivot block 2250. The side mount pivot block comprises a tube 2255 formed in the top/apex of the frame 2205. The tube 2255 is shown to have a generally cylindrical outer surface, but the outer surface could define a square or any other shape. The tube, however, defines a cylindrical passage 2257. A collar 2259 is formed at the top of the tube 2255 and defines a hole 2261 which extends form the top of the collar into the passage 2257.

An axle 2400 is received in the passage 2257 of the pivot block 2250 to rotate about an axis of the axle. The axle 2400, as shown, has a diameter less than the diameter of the passage 2257. Thus, the side mount 2200 can have end plates, rings, or bearings (not shown) which position the axle 2400 in the passage 2257, such that wobble of the axle is minimized. Alternatively, and preferably, the axle 2400 could have a diameter just slightly smaller than the diameter of the passage, such that wobble of the axle will be minimized due to its size (in which case, the passage becomes the journal for the axle).

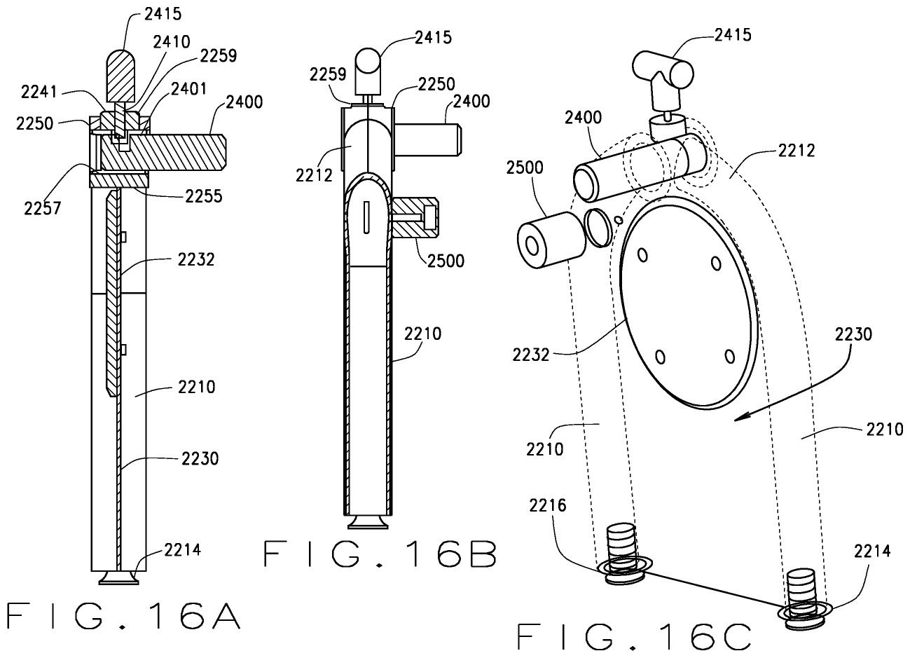

As seen particularly in FIG. 16A, the axle 2400 has at least one positioning hole 2401 positioned to be aligned with the passage 2261 of the collar 2259. In lieu of a tethered positioning pin, the positioning member for the side mount 2400 comprises a retractable pin 2410 which is received in the collar passage 2261 and is sized and shaped to be removably inserted into the at least one positioning hole 2401, thereby restricting free rotation of the axle 2400 about the axle's primary axis. A handle 2415 positioned atop the retractable pin 2410 facilitates retraction of the retractable pin. As can be appreciated, when the pin 2410 is inserted in the positioning hole 2401, the swim ladder is rotationally fixed in its then present position. Pulling up on the handle 2415 will remove the pin 2410 from the axle hole 2401, allowing for rotation of the swim ladder. The collar 2261 includes a cap which closes the top of the collar. The cap has a hole through which the pin 2410 extends, and the end of the pin is sized, shaped, or otherwise configured such that it cannot be pulled out of the side mount. Thus, the pin 2410 will be maintained in the side mount, avoiding the need for a tether. Although not shown, the pin and handle can be spring biased downwardly to reduce the potential for the pin to be inadvertently removed from the axle hole 2401. Additionally, if spring biased, then as the axle rotates when the ladder is pivoted, the locking pin will snap into the hole 2401 when the hole comes into alignment with the pin.

A stop 2500 projects outwardly from one side of the semicircular top member 2212. The stop 2500 extends in the same direction as the axle 400 and is positioned behind and below the axle. As such, the stop 2500 is mounted to the top member 2212 slightly above the rear leg 2210 of the frame. As can be appreciated, the stop will prevent excess rotation of the swim ladder 300.

As various changes could be made in the above constructions without departing from the scope of the claimed invention, it is intended that all matter contained in the above description or shown in the accompanying drawings shall be interpreted as illustrative and not in a limiting sense. For example, the dock module 100 may be a floating dock, a permanent dock, a pier, a swim raft, the deck of a boat, etc. The swim ladder could be configured to have a single side rail, rather than two side rails. Further, the swim ladder assembly could be modified to have a single side mount, rather than two opposed side mounts, as shown. These examples are merely illustrative.

1. A swim ladder assembly, comprising:
at least one side mount adapted to be mounted to a structure comprising a top surface, a side or end surface, and an edge at a junction between said top and side or end surfaces; the side mount comprising a side mount pivot block positioned to be above the top surface of the structure and rearwardly of said edge when the side mount is mounted to the structure; and
a swim ladder rotatably mounted to said at least side mount, said swim ladder being rotatable about a pivot axis between an in-use position in which said ladder extends into water and an out-of-use position in which said ladder does not extend into water; said swim ladder comprising:
at least one side rail comprising:
an upper portion having upper edge defining an arc having a radius R, said radius R being approximately equal to distance between a bottom of said at least one side mount and said side mount pivot block, said arc defining an angle of at least 90° and preferably less than 270°;
a side rail pivot block positioned in said upper portion to be at an approximate center of a circle defined by said arcuate upper edge;
at least one leg rail operatively connected to said upper portion; and
at least one step fixed to said at least one leg rail; and
at least one axle which extends through said side mount pivot block and said side rail pivot block to define said pivot axis about which said swim ladder is rotatable;
wherein, said side rail upper portion is sized such that, as said swim ladder is pivoted between its in-use position and its out-of-use position, the arcuate edge of said upper portion contacts the top surface of said structure, such that the ladder rides on the arcuate outer edge of the upper portion as the ladder is pivoted from or to the in use position.

2. The swim ladder assembly of claim 1 wherein the swim ladder assembly comprises two opposed side mounts with said swim ladder being mounted between the side mounts for rotation about the pivot axis, and/or wherein the swim ladder comprises two opposed side rails.

3. The swim ladder assembly of claim 1, wherein the upper portion of said side rail comprises an arcuate handle defining said arcuate edge and having opposite ends, a pivot support bar connected at one of said ends of said arcuate handle and extending through the circle defined by said accurate edge, a front member extending from the other end of said handle, and a rear member extending from a forward end of said pivot support bar; said side rail pivot block being positioned along said pivot support bar; and said leg rail being depending from said front and rear members of said side rail.

4. The swim ladder assembly of claim 1, wherein said front member defines a dock support bar, said front member being positioned such that, when the swim ladder is in said in-use position, said dock support bar extends generally vertically and is adjacent the side surface of said support.

5. The swim ladder assembly of claim 4 wherein said side rail includes a cushioning stop positioned on said front member to be between said side rail and said side surface of said structure when in said in-use position.

6. The swim ladder assembly of claim 1, wherein the leg rail further comprises a front leg and a rear leg; said at least one step being operatively connected to and extending between said front leg and said rear leg.

7. The swim ladder assembly of claim 6 wherein an upper most step of said at least one step is positioned to be generally level with the top surface of said structure when said swim ladder is in its in-use position.

8. The swim ladder assembly of claim 6 including at least one step bracket extending between said front and rear legs, said at least one step being secured to said at least one bracket.

9. The swim ladder assembly of claim 1, said at least one side mount comprises:
a top member, a forward member extending downwardly from a forward end of said top member, and a rear member extending downwardly from a rear end of said top member; and
a bracket adapted to mount said at least one side mount to said structure.

10. The swim ladder assembly of claim 9, wherein said bracket comprises at least one connector sized and shaped to mount said side mount to said structure.

11. The swim ladder assembly of claim 9 wherein said forward member of said side mount is sized to extend below said structure top surface when mounted to said structure.

12. The swim ladder assembly of claim 1, wherein said side mount pivot block includes a hole in an outer surface thereof and said side rail pivot block includes a hole in an outer surface thereof;
said axle being generally cylindrical and having an outer surface and opposed ends; said axle comprising:
a locking hole formed in said outer surface of said axle and positioned to be aligned with the hole of one of said side mount pivot block and said side rail pivot block;
at least two positioning holes formed in said outer surface of said axle and positioned to be aligned with the hole of the other of said side mount pivot block and said side rail pivot block;
a locking member sized to be received in said locking hole to rotationally fix said axle relative to said one of said side mount pivot block and said side rail pivot block; and
a positioning member removably receivable in a selected positioning hole; whereby, when said positioning member is engaged with a selected one of said at least two positioning holes, said swim ladder is rotationally fixed relative to said side mount, and, wherein when said positioning member is disengaged from said at least two positioning holes, said swim ladder may be rotated relative to said side mount about said pivot axis.

13. The swim ladder assembly of claim 12 wherein said locking hole is positioned to be aligned with the hole of said side rail pivot block and said at least two positioning holes are positioned to be aligned with the hole of said side mount pivot block.

14. The swim ladder assembly of claim 1 wherein said leg rail defines an angle with the vertical when said swim ladder is in its in-use position, such that a bottom of said leg rail is spaced further from said pivot axis more than a top of said leg rail.

15. The swim ladder assembly of claim 14 wherein said angle is about 25°-35°, and preferably about 30°-33°.

16. A swim ladder assembly, comprising:
a pair of opposed side mounts adapted to be secured to an upper surface of a structure, adjacent an edge of the structure;
a swim ladder sized to fit between the opposed side mounts; the swim ladder comprising a pair of opposed side rails and a plurality of steps extending between said side rails; said side rails comprising an upper arcuate rail portion defining a radius R;
first and second pivot blocks; one of said first and second pivot blocks being positioned on said side mounts above a bottom of said side mounts by a distance approximately equal to the radius R; the other of said first and second pivot blocks being positioned on said side rails at the center of the circle defined by the arcuate rail portion, each pivot block comprising an outer surface and opposed side surfaces, a passage extending through said pivot blocks to open at the side surfaces of said pivot blocks, and a hole extending from said outer surface of said pivot blocks to said passage;
a pair of axles shaped and sized to pass through the passages of both said first and second mount pivot blocks to rotatably mount said swim ladder between said side mounts; said axles being generally cylindrical and having an outer surface and opposed ends; each said axle comprising:
a locking hole formed in said outer surface of said axle and positioned to be aligned with the hole of said first pivot block;
at least two positioning holes formed in said outer surface of said axle and positioned to be aligned with the hole of the second pivot block;
a locking member sized to be received in said locking hole to rotationally fix said axle relative to said first pivot block; and
a positioning member sized to removably engage said hole of said second pivot block; whereby, when said positioning member is engaged with a selected one of said at least two positioning holes, said swim ladder is rotationally fixed relative to said side mounts, and, wherein when said positioning member is disengaged from said at least two positioning holes, said swim ladder may be rotated relative to said side mounts about a pivot axis.

17. The swim ladder assembly of claim 16 wherein said first pivot blocks are positioned on said side rails and said second pivot blocks are positioned on said side mounts.
